(19) United States
(12) Patent Application Publication
(10) Pub. No.: US 2012/0287042 A1
(43) Pub. Date: Nov. 15, 2012

(54) PORTABLE TERMINAL AND DISPLAY OUTPUT METHOD THEREOF

(75) Inventor: Xingwen Chen, Beijing (CN)

(73) Assignees: Beijing Lenovo Software Ltd., Beijing (CN); Lenovo (Beijing)) Limited, Beijing (CN)

(21) Appl. No.: 13/511,434

(22) PCT Filed: Nov. 12, 2010
(86) PCT No.: PCT/CN2010/001816

§ 371 Date: May 23, 2012

(30) Foreign Application Priority Data
Nov. 24, 2009 (CN) 20091038739.5

(51) Int. Cl. G06F 3/033

(52) U.S. Cl. 345/157

(57) ABSTRACT

A portable terminal and a display output method for the portable terminal are provided. The portable terminal comprises at least a first system and a second system, a display device including a display area shared by the first and second systems, and an input device for controlling movement of a cursor, wherein output data from the first system is displayed on a first part of the display area controlled by the first system, and output data from the second system is displayed on a second part of the display area controlled by the second system. The display output method comprises: acquiring, by the first system, a trigger switching event corresponding to an input operation on the input device when the cursor is located on the first part; controlling, by the first system, the input device to switch to be connected to the second system based on the trigger switching event; and causing the cursor to be displayed on the second part when the input device is connected to the second system. According to the invention, a seamless switching of a display output between display parts of two systems can be accomplished through operations of the cursor, and thereby the switching time for display output may be reduced.

### FIELD OF THE INVENTION

The invention relates to the field of communication technology, and more particularly, to a portable terminal and a display output method thereof.

### BACKGROUND OF THE INVENTION

A hybrid Personal Computer (PC) is a PC in which a further system is embedded into an existing PC where only one system is included. Different systems can cooperate with each other such that their respective advantages can be fully exploited. A common existing hybrid system usually includes a master system (such as Vista) and a slave system (such as WinCE). The master system and the slave system may share the keyboard, network card, display screen and others.

In an existing hybrid PC, a dual-system divi-screen display is employed, where the two systems can be assigned with a part of the screen as required simultaneously so as to display thereon. In researching the prior art, the inventors of the present invention had found that a display switch shall be arranged on the terminal beforehand so that a divi-screen display can be employed in an existing hybrid PC, where the display switch controls the input device to be used by different systems and input-output operations are performed on the respective parts of the screen. The arrangement of the switch complicates the operations and lowers the user experience when switching between different systems. For example, in a dual-screen display mode, when the master system performs a display operation on its screen, a user cannot directly operate if he/she wants to display on the screen of the slave system, and shall manipulate the switch to wait until the switching is finished.

### SUMMARY OF THE INVENTION

The object of the present invention is to provide a portable terminal and a display output method for the portable terminal to address the problem of the prior art that a switch is necessary for switching the display and thus the experience of the user is degraded due to the troublesome switching.

In order to achieve the above object, the embodiments of the present invention provide the following solutions.

In one aspect, a display output method of a portable terminal is provided, which is applied to the portable terminal including at least a first system and a second system, the portable terminal including a display device including a display area shared by the first and second systems, and an input device for controlling movement of a cursor, output data from the first system being displayed on a first part of the display area controlled by the first system, and output data from the second system being displayed on a second part of the display area controlled by the second system, the display output method including:
acquiring, by the first system, a trigger switching event corresponding to an input operation on the input device when the cursor is located on the first part,
controlling, by the first system, the input device to switch to be connected to the second system based on the trigger switching event, and
causing the cursor to be displayed on the second part when the input device is connected to the second system.

Preferably, the method further includes, before controlling the input device to switch to be connected to the second system based on the trigger switching event, determining a state of the second system, waking the second system up if it is determined that the second system is in a non-operating state, and then the second system displaying output data on the second part.

Preferably, the trigger switching event corresponding to an input operation includes one of the following: the cursor moving to a boundary of the first part of the display area; receiving a click command requesting switching to the second part; or receiving a selection command requesting switching to the second part.

Preferably, the first system includes a first storage and the second system includes a second storage, a communication channel being established between the first storage and the second storage, the method further includes: acquiring by the first system a data movement event inputted from the input device when the cursor is located on the first part, and transmitting by the first system data corresponding to the data movement event via the communication channel from the first storage to the second storage.

Preferably, the data movement event includes one of the following: the cursor moving to drag data from the first part to the second part; the cursor moving to copy data from the first part to the second part; or receiving a command requesting transmission of data from the first system to the second system.

Preferably, transmitting by the first system data corresponding to the data movement event via the communication channel from the first storage to the second storage includes: acquiring a destination address corresponding to the location of the cursor on the second part, and transmitting the data via the communication channel from the first storage to a storage space corresponding to the destination address in the second storage.

Preferably, the method further includes: acquiring by the second system a full-screen display command inputted from the input device when the cursor is located on the second part, switching by the second system based on the full-screen display command, the first part from being under the control of the first system to being under the control of the second system, controlling by the second system the input device to perform a full-screen display on the display area included of the first and second parts, and causing the first system to enter into a background running state.

Preferably, the method further includes: switching the first part to being under the control of the first system when the second system acquires a dual-screen display command inputted from the input device, and causing the first system to enter into a foreground display state.

In another aspect, a portable terminal is provided, including a first system, a second system, a display device including a display area shared by the first and second systems, and an input device for controlling movement of a cursor, output data from the first system being displayed on a first part of the display area controlled by the first system, and output data from the second system being displayed on a second part of the display area controlled by the second system, the first system including:
a trigger event acquirement unit for acquiring a trigger switching event corresponding to an input operation on the input device when the cursor is located on the first part; and
a connection control unit for controlling the input device to switch to be connected to the second system based on the trigger switching event, the cursor being displayed on the second part when the input device is connected to the second system.

Preferably, the first system further includes a state determination and performance unit for determining state of the second system and waking the second system up if it is determined that the second system is in a non-operating state, and the second system includes a display output control unit for controlling output data to be displayed on the second part.

Preferably, the first system further includes a first storage and the second system further includes a second storage, a communication channel being established between the first storage and the second storage, and the first system further includes: a data movement acquirement unit for acquiring a data movement event inputted from the input device when the cursor is located on the first part, and a data transmission unit for transmitting data corresponding to the data movement event via the communication channel from the first storage to the second storage.

Preferably, the data transmission unit includes a destination address acquirement unit for acquiring a destination address corresponding to the location of the cursor on the second part, and a data transmission performance unit for transmitting the data via the communication channel from the first storage to a storage space corresponding to the destination address in the second storage.

Preferably, the second system includes: a display command acquirement unit for acquiring a full-screen display command inputted from the input device when the cursor is located on the second part, a display switching control unit for switching the first part from being under the control of the first system to being under the control of the second system based on the full screen display command, and a full screen display output unit for controlling the input device to perform a full-screen display on the display area formed by the first and second parts, and the first system further includes a running state control unit for controlling the first system to enter into a background running state in the full-screen display mode.

Preferably, the display command acquirement unit further acquires a dual-screen display command inputted from the input device, the display switching control unit further controls the first part to switch to being under the control of the first system, and the running state control unit further controls the first system to enter into a foreground display state when the first part is under the control of the first system.

In another aspect, a portable terminal is provided, including a first system, a second system, a display device including a display area shared by the first and second systems and an operating mode selection module, wherein the display area includes a first part and a second part, and wherein the operating mode selection module selects an operating mode where output data from the first system and/or output data from the second system is connected to the first part and/or second part respectively.

Preferably, the operating mode selection module selects a first operating mode where the first and second parts are connected to output data from the first system and output data from the second system, respectively, or the first and second parts are collectively connected to output data from the first system or output data from the second system.

Preferably, when the first and second parts are connected to output data from the first system and output data from the second system, respectively, the operating mode selection module selects a second operating mode, so that the first and second parts are collectively connected to output data from the first system or output data from the second system.

Preferably, when the first and second parts are collectively connected to output data from the first system, the operating mode selection module selects a third operating mode, so that the first and second parts are collectively connected to output data from the second system.

Preferably, when the first and second parts are collectively connected to output data from the second system, the operating mode selection module selects a fourth operating mode, so that the first and second parts are collectively connected to output data from the first system.

Preferably, when the first and second parts are collectively connected to output data from the first system, the operating mode selection module selects a fifth operating mode, so that the first and second parts are connected to output data from the first system and output data from the second system, respectively.

Preferably, when the first and second parts are collectively connected to output data from the second system, the operating mode selection module selects a sixth operating mode, so that the first and second parts are connected to output data from the first system and output data from the second system, respectively.

Preferably, the portable terminal further includes a power source control module for supplying power to the first part and/or the second part according to the operating mode selected by the operating mode selection module.

In another aspect, a portable terminal is provide, including at least a first system, a second system, a display device including a display area shared by the first and second systems, and an input device, the portable terminal including:
a first switch connected to the first system, the second system and a first sub-screen corresponding to the first part of the display area, respectively,
a second switch connected to the second system, the first system and a second sub-screen corresponding to the second part of the display area, respectively, and
a controller connected to the first switch and the second switch respectively to control the first switch to be connected to the first system and the second switch to be connected to the second system, wherein the first system controls input data of the first system to be displayed on the first part of the display area, and the second system controls input data of the second system to be displayed on the second part of the display area.

Preferably, the portable terminal further includes: a power source control module for supplying power to the first sub-screen and/or the second sub-screen based on the control of the controller.

Preferably, the controller controls the first switch and the second switch to be connected to the second system according to a second system full-screen display command, and wherein the second system controls input data of the second system to be displayed on an area formed by the first and second parts of the display area.

Preferably, the controller controls the first switch and the second switch to be connected to the first system according to a first system full-screen display command, and wherein the first system controls input data of the first system to be displayed on an area formed by the first and second parts of the display area.

According to the technical solutions of the embodiments of the present invention, the first system acquires a trigger switching event corresponding to the input operation on the input device when the cursor is located on the first part of the display area, controls the input device to switch to be connected to the second system based on the trigger switching event, and causes the cursor to be displayed on the second part when the input device is connected to the second system. When the embodiments of the present inventions are applied to a hybrid portable terminal to perform a display output operation, a seamless switching of the display output between the display parts of two systems can be accomplished through the operations of the cursor when moving the input device, and thereby the switching time for the display output is reduced and the user operation is facilitated.

### BRIEF DESCRIPTION OF THE DRAWINGS

FIG. 1 is a flowchart illustrating a display output method of a portable terminal according to a first embodiment of the invention;

FIG. 2 is a flowchart illustrating a display output method of a portable terminal according to a second embodiment of the invention;

FIG. 3 is a flowchart illustrating a display output method of a portable terminal according to a third embodiment of the invention;

FIG. 4 is a flowchart illustrating a display output method of a portable terminal according to a fourth embodiment of the invention;

FIG. 5 is a structural schematic diagram showing a portable terminal where a display output method of the invention is applied;

FIG. 6 is a block diagram showing a portable terminal according to a first embodiment of the invention; and

FIG. 7 is a block diagram showing a portable terminal according to a second embodiment of the invention.

### DETAILED DESCRIPTION OF PREFERRED EMBODIMENTS

In the several embodiments of the invention below, some are directed to a display output method of a portable terminal, and others are directed to a portable terminal.

In the following, the embodiments of the present invention will be described in detail with reference to the figures, such that the solution of the embodiments are thoroughly conveyed to those skilled in the art and the foregoing objects, features and advantages of the present invention will be more apparent.

A portable terminal according to the embodiments of the invention includes a first system, a second system, a display device including a display area shared by the first and second systems, and an input device for controlling movement of a cursor. The power consumption of the first system may be higher than that of the second system. For example, the first system is based on an X-86 processor, which usually has a high speed and a high power consumption and can support a general Windows operating system to process tasks requiring a relative high processing capability, while the second system is based on an ARM processor, which usually has a low speed and a low power consumption and can only support applications of less complexity but has a long standby time.

Furthermore, in the portable terminal of the invention, the first system may further include a first storage, the second system may further include a second storage, and a communication channel for data transmission may be established between the first storage and the second storage.

In the embodiments of the invention below, output data from the first system is displayed on a first part of the display area controlled by the first system, and output data from the second system is displayed on a second part of the display area controlled by the second system. The first part may be a part or the whole of the display area. Similarly, the second part may be a part or the whole of the display area.

FIG. 1 is a flowchart illustrating a display output method of a portable terminal according to a first embodiment of the invention.

At step 101, the first system acquires a trigger switching event corresponding to an input operation on the input device when the cursor is located on the first part.

Particularly, the trigger switching event corresponding to the input operation may include one of the following: the cursor moving to a boundary of the first part of the display area, when, for example, the user manipulates a mouse to move the cursor to the boundary between the first part and the second part in a dual-screen display mode where the first part and the second part form the whole display area; receiving a click command requesting switching to the second part when for example the user operates the mouse to click a virtual key for switching to the second part on the display area; or receiving a selection command requesting switching to the second part when for example the user operates the right key on the mouse to select from the displayed menu an option for switching to the second system.

In the embodiment of the invention, the input device may be a peripheral device that can function in the display area as a mouse, including such as a mouse, a touch panel and others.

At step 102, the first system controls the input device to switch to be connected to the second system based on the trigger switching event.

The input device is connected to the first system when the cursor moves in the first part. The first system displays its own output data on the first part, and may perform various application operations in the first part. Meanwhile, the second system may be in an inactive state and output data of the second system may be correspondingly displayed on the second part of the display area. Alternatively, the second system may come into a standby state or a sleep state, and the second part may be correspondingly in a black-screen state.

If the first part and the second part both having output data displayed thereon, in response to a switch trigger event (for example, the cursor moves to the boundary between the first part and the second part), the first system controls the input device to be connected to the second system according to the switch trigger event.

At step 103, the cursor is displayed on the second part when the input device is connected to the second system. Then, the current procedure ends.

The cursor moves smoothly and seamlessly from the boundary to the second part and is displayed on the second part when the input device is connected to the second system. At this time, the input device is under the control of the second system so as to cause the cursor to move in the second part, and the second system may perform respective application operations.

Accordingly, the first part controlled by the first system may only display output data, or may come into a sleep state or a standby state as required to save system consumption.

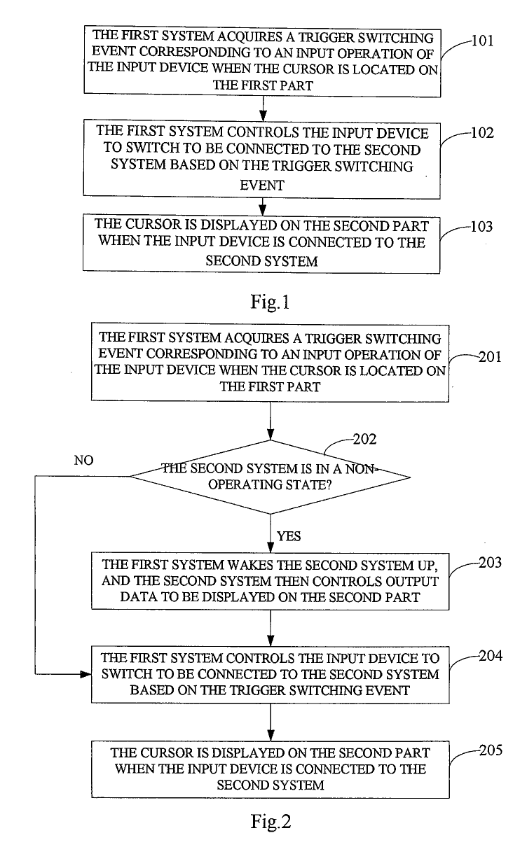

FIG. 2 is a flowchart illustrating a display output method of a portable terminal according to a second embodiment of the invention, where the procedure of a display output operation according to a state of the second system is shown.

At step 201, the first system acquires a trigger switching event corresponding to an input operation on the input device when the cursor is located on the first part.

Particularly, the trigger switching event corresponding to the input operation may include one of the following: the cursor moving to a boundary of the first part of the display area, when, for example, the user operates the mouse to move the cursor to the boundary between the first part and the second part in a dual-screen display mode where the first part and the second part form the whole display area; receiving a click command requesting switching to the second part when for example the user operates the mouse to click a virtual key for switching to the second part on the display area; or receiving a selection command requesting switching to the second part when for example the user operates the right key on the mouse to select from the displayed menu an option for switching to the second system.

In the embodiment of the invention, the input device may be a peripheral device that can function in the display area as a mouse, including such as a mouse, a touch panel and others.

At step 202, it is determined whether the second system is in a non-operating state or not. If yes, proceed to step 203; and otherwise, proceed to step 204.

The determination is performed because the first system may be in an operating state and the second system may be in a non-operating state (such as a standby state or a sleep state) or in an operating state of displaying output data (but not performing application operations) when the first and second parts are in a dual-screen display mode.

At step 203, the first system wakes the second system up, and the second system then controls the output data to be displayed on the second part.

The input device is connected to the first system when the cursor moves in the first part. The first system displays the output data of its own on the first part, and may perform various application operations in the first part. Meanwhile, the second system enters into a standby state or a sleep state and the second part may is correspondingly in a black-screen state. If a trigger event (for example, the cursor moves to the boundary between the first part and the second part) occurs, the first system firstly wakes the second system up, and the second system then controls the output data to be displayed on the second part which is originally in a black-screen state.

At step 204, the first system controls the input device to switch to be connected to the second system based on the trigger switching event.

After the second system displays the output data on the second part, the first system switches the input device to be connected to the second system.

At step 205, the cursor is displayed on the second part when the input device is connected to the second system. Then, the current procedure ends.

The cursor moves smoothly and seamlessly from the boundary to the second part and is displayed on the second part when the input device is connected to the second system. At this time, the input device is under the control of the second system so as to cause the cursor to move in the second part, and the second system may perform respective application operations.

Accordingly, the first part controlled by the first system may only display output data, or may come into a sleep state or a standby state as required to save system consumption.

In the embodiment, when the first and second systems operate at the same time, for example the left half part of the screen is under the control of the first system running on an INTEL hardware platform, and the right half part of the screen is under the control of the second system running on an embedded platform, the user may control the cursor to move freely and smoothly between the two parts of the screen through manipulation of the mouse.

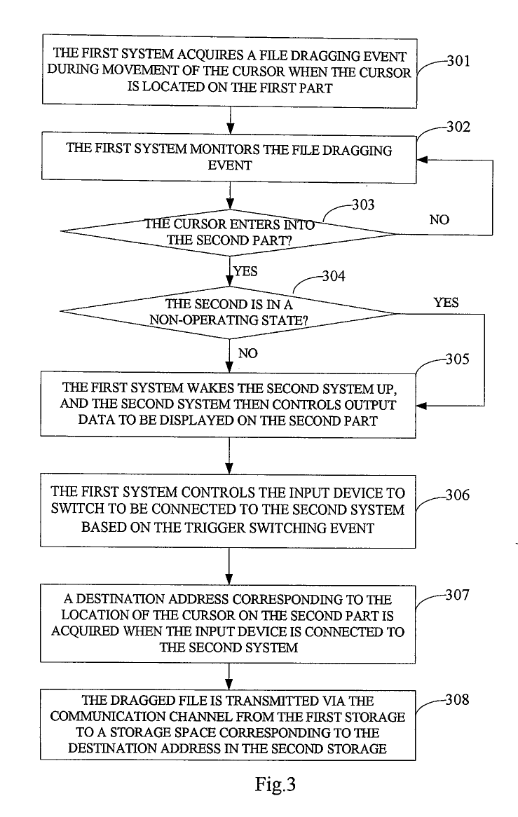

FIG. 3 is a flowchart illustrating a display output method of a portable terminal according to a third embodiment of the invention, where the procedure of dragging a file from the first part to the second part when the first and second systems are in a dual-screen display mode is shown.

At step 301, the first system acquires a file dragging event during movement of the cursor when the cursor is located on the first part.

In the embodiment, at the beginning, the first part and the second part of the display area may simultaneously display output data of the first system and output data of the second system, respectively.

When the cursor is located on the first part, the input device performs application operations in the platform of the first system and displays them on the first part. When the user manipulates the input device to click a file displayed on the first part and moves it to the second part, such an operation corresponds to a file dragging event.

At step 302, the first system monitors the file dragging event.

The first system monitors the file dragging event, i.e., the movement track of the file. During movement of the file, the file dragging event substantially includes two events, i.e., a cursor movement event and a file movement event.

At step 303, it is determined whether the cursor enters into the second part or not. If yes, the method proceeds to step 304. Otherwise, the method returns to step 302.

When the file moves, a movement destination of the file may be still within the first part, or may possibly go into the second part after passing through the boundary between the first part and the second part. In other words, the movement destination may be the second system.

At step 304, it is determined whether the second is in a non-operating state or not. If yes, the method proceeds to step 305. Otherwise, the method proceeds to step 306.

The first system may be in an operating state and the second system may be in a non-operating state (such as a standby state or a sleep state) or in an operating state of displaying output data (but not performing application operations) when cursor enters into the second part.

At step 305, the first system wakes the second system up, and the second system then controls the output data to be displayed on the second part.

The input device is connected to the first system when the cursor drags a file in the first part. The first system displays its own output data on the first part. Meanwhile, the second system enters into a standby state or a sleep state, and the second part is correspondingly in a black-screen state. When the file moves to the boundary between the first part and the second part, the first system wakes the second system up from a standby state or a sleep state and the second system then controls the output data to be displayed on the second part which is originally in a black-screen state.

At step 306, the first system controls the input device to switch to be connected to the second system based on the trigger switching event.

After the second system displays the output data on the second part, the cursor may move smoothly and seamlessly from the boundary into the second part as the movement of the file, and the first system may switch the input device to be connected to the second system.

At step 307, a destination address corresponding to the location of the cursor on the second part is acquired when the input device is connected to the second system.

The file is displayed within the second part when the input device is connected to the second system. The file may keep on moving in the second part to a destination folder. The second system acquires address information of the destination folder, and transmits the address information to the first system via a communication channel (for example, I²C) between the first storage and the second storage.

At step 308, the dragged file is transmitted via the communication channel from the first storage to a storage space corresponding to the destination address in the second storage, and the current procedure ends.

The first system may transmit a file stored in the first storage via the communication channel to the destination folder in the second storage after acquiring the address of the destination folder. In this way, a visual data management may be achieved where a file is dragged between two screens in a dual-screen display mode.

In addition to the foregoing embodiments where data is visually dragged between two systems, the embodiments of the invention can also be applied to the following scenarios: the data is visually dragged from the first part to the second part when the mouse operates within the first part controlled by the first system, the right key is clicked to select a copy command from the pull down menu, the cursor moves from the first part to the second part, and finally a past operation is performed in the second part; or, the data is visually transmitted between two systems when the first system controls the display area for a full-screen display, the second system operates in the background state, the right key is clicked on a file in the display area, and a command for transmitting the file to the second system is selected from the menu. For example, when the user selects an audio file to be played in the second system, the first system transmits the audio file via a communication channel to the second system, and wakes the second system up from the background. The second system may operate in a full screen-display mode or operate in a dual-screen display mode along with the first system after being waken up. No matter which display mode is used, the input device switches to be connected to the second system, and an audio player pops up on the whole screen or the second part controlled by the second system to play the audio file.

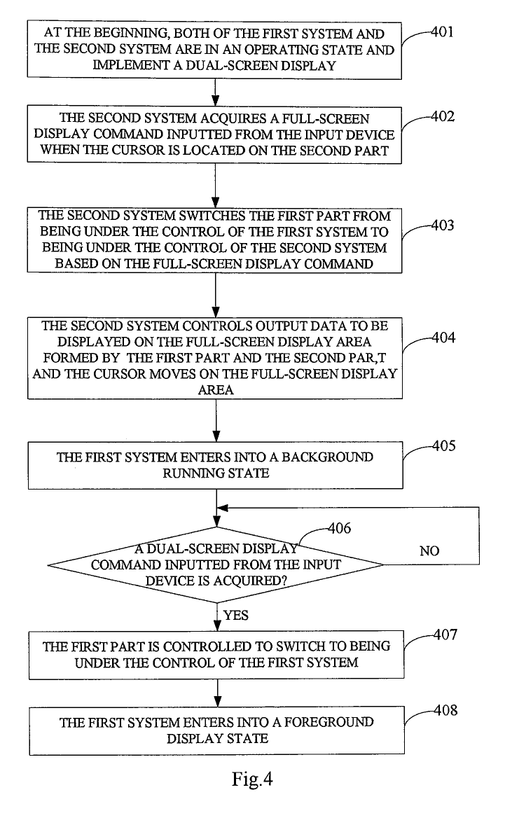

FIG. 4 is a flowchart illustrating a display output method of a portable terminal according to a fourth embodiment of the invention, where the procedure of switching the portable terminal between a full-screen display mode controller by one system and a dual-screen display mode controlled by two systems is shown.

At step 401, at the beginning, both of the first system and the second system are in an operating state and implement a dual-screen display mode.

That is, at the beginning, output data from the first system and output data from the second system are displayed on a first part and a second part of the display area, respectively.

At step 402, the second system acquires a full-screen display command inputted from the input device when the cursor is located on the second part.

The input device is connected to the second system when the cursor is located on the second part. The second system controls the input operation. It is pre-defined that a full-screen display command may be acquired either when the cursor moves to the boundary of the second part, or when a virtual button arranged on the boundary of the second part is clicked.

At step 403, the second system switches the first part from being under the control of the first system to being under the control of the second system based on the full-screen display command.

At step 404, the second system controls output data to be displayed on a full-screen display area formed by the first part and the second part, and the cursor moves on the full-screen display area.

At step 405, the first system enters into a background running state.

When the second system controls a full-screen display to be performed, the first system may enter into the background running state, such as a sleep state or a standby state.

Similarly as the foregoing step 401 to step 405, in a dual-screen display mode, firstly, the cursor may smoothly move from the second part to the first part, and then a full-screen display command inputted from the input device is acquired in the first part. For example, it may be pre-defined that a full-screen display command may be acquired either when the cursor moves to the boundary of the first part, or when a virtual button arranged on the boundary of the first part is clicked.

At step 406, the second system determines whether a dual-screen display command inputted from the input device is acquired or not. If yes, the method proceeds to step 407. Otherwise, the method returns to step 406.

At step 407, the first part is controlled to switch to being under the control of the first system.

When the second system operates in a full-screen display mode, it may be pre-defined that a dual-screen display command corresponds to the movement of the cursor to the boundary of the display area. The second system controls the first part of the display area to switch to being under the control of the first system in such case.

At step 408, the first system enters into a foreground display state, and the current procedure ends.

The second system wakes the first system from the background, and the display area is in a dual-screen display mode. The input device is still under the control of the second system, and application operations are performed in the second part. In this way, a visual data management can be achieved and the cursor may move between two screens according to the foregoing embodiments of the invention.

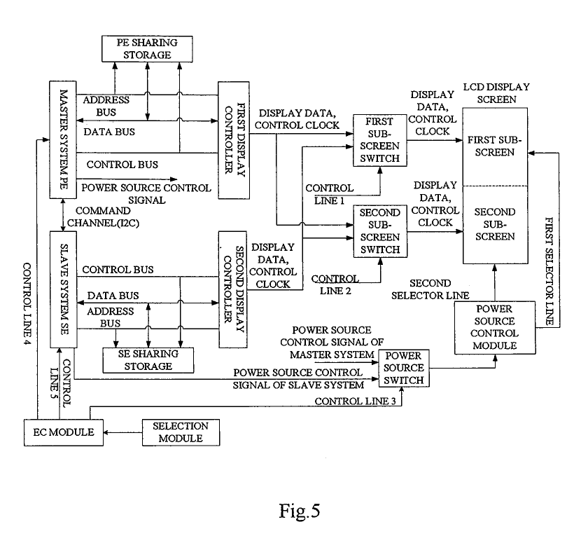

In the embodiment, a dual-system portable terminal including a first system and a second system may be a notebook as shown in FIG. 5. FIG. 5 is a schematic diagram showing the logic structure of the notebook. The notebook may include a LCD, a master system PE, a slave system SE, a master system sharing storage, a slave system sharing storage, a power source control module, a first display controller, a second display controller, a first sub-screen switch, a second sub-screen switch, a power source switch, a selection module and an embedded controller (EC) module. The procedure of switching between two screens is described below with reference to FIG. 5.

In the embodiment, the LCD may be divided logically into a first sub-screen and a second sub-screen, and may control the display of the two sub-screens in cooperation with the power source control module and the display controllers. The selection module is connected to the EC module. The EC module is connected to the first sub-screen switch, the second sub-screen switch, the power source switch, the master system and the slave system via control lines 1-5, respectively. The power source switch is connected to the master system, the slave system and the power source control module. The master system and the slave system are connected to each other via an I²C command channel. The master system connects to the first display controller via an address bus, a control bus and a data bus of the master system, and interacts with them according to a bus handshake protocol. The master system sharing storage is connected onto the address bus, the control bus and the data bus of the master system. The slave system is connected to the second display controller via an address bus, a control bus and a data bus of the slave system, and interacts with them according to a bus handshake protocol. The slave system sharing storage is connected onto the address bus, the control bus and the data bus of the slave system. The first display controller and the second display controller output display data, control clocks and others. The first sub-screen and the second sub-screen are connected to outputs of the first sub-screen switch and the second sub-screen switch, respectively. An input of the first sub-screen switch is connected to the first display controller and the second display controller, respectively, and an input of the second sub-screen switch is also connected to the first display controller and the second display controller, respectively. That is, two alternative systems may be set for the first sub-screen and the second sub-screen. The two alternative systems may be the operating systems running in the master and slave systems.

The power source control module is connected between the power source and the sub-screens. It is connected to the first sub-screen and the second sub-screen via a first selector line and a second selector, respectively. A selector line is turned on only when the power source control module selects one of the selector lines, so as to connect a respective sub-screen with the power source to supply power to the sub-screen.

In a first scenario, the selection module selects an operating mode where the master operating system operates alone while the slave operating system does not operate. The EC module generates a system control signal to indicate the operating mode. In the embodiment, the display mode is such one where the first sub-screen and the second sub-screen display information to be displayed of the master operating system. The LCD is completely used by the master system as a single device. The EC module instructs the first sub-screen switch and the second sub-screen switch to select to connect an input of the first display controller. The first sub-screen and the second sub-screen form a united physical display screen, and display information to be displayed of the master operating system under the control of the first display controller which is connected to the master system. The master operating system may adjust an output resolution as required at this time. Meanwhile, the EC module generates a power source control signal, indicating supplying power to both the first and second sub-screens. When the power source switch selects to forward the power source control signal generated by the EC module to the power source control module, the power source control module selects both the first selector line and the second selector line according to the power source control signal. In other words, both the first selector line and the second selector line are supplied with power. If the master operating system also generates a power source control signal, the power source switch may select to forward the power source control signal generated by the master operating system to the power source control module.

In a second scenario, the selection module selects an operating mode where the slave operating system operates alone while the master operating system does not operate. The EC module generates a system control signal indicating the operating mode. The scenario is similar to the first scenario, except that the EC module instructs both of the first sub-screen switch and the second sub-screen switch to select an input connected to the second display controller. The first sub-screen and the second sub-screen are both under the control of the second display controller, and display information to be displayed of the slave operating system. The power source control module selects both the first selector line and the second selector line similarly. The slave operating system may adjust the output resolution as required at this time.

In either the first scenario or the second scenario, the EC module may only instruct one of the first sub-screen switch and the second sub-screen switch to select an to input connected to the first display controller or the second display controller, and may instruct the power source control unit to only select the corresponding one of the selector lines.

In a third scenario, the selection module selects an operating mode where both the master operating system and the slave operating system operate. The EC module generates a system control signal indicating that both the master and slave operating systems operate. In the embodiment, both the master operating system and the slave operating system display on the LCD. The display mode selected by the selection module is such one where the first sub-screen and the second sub-screen display information to be displayed of the master operating system and of the slave operating system, respectively. The EC module instructs the first sub-screen switch and the second sub-screen to select an input connected to the first display controller and an input connected to the second display controller, respectively. The first sub-screen switch connects the first display controller to the first sub-screen, and the second sub-screen switch connects the second display controller to the second sub-screen. That is, the first sub-screen displays the information to be displayed of the master operating system, and the second sub-screen displays the information to be displayed of the slave operating system. Meanwhile, the EC module generates a power source control signal, so that the power source control module selects both the first and second selector lines according to the power source control signal. At the time, the first sub-screen displays information to be displayed of the master operating system under the control of the first display controller, and the second sub-screen displays information to be displayed of the slave operating system under the control of the second display controller. The master operating system and the slave operating system display on one and the same physical display screen.

When the scenario changes from the first scenario to the third scenario, the master system is the first hardware system, and the master operating system is the first operating system. The slave system is the second hardware system, and the slave operating system is the second operating system. The first sub-screen is the first part of the display area and the second sub-screen is the second part of the display area. The second sub-screen switch is the second switch. When the scenario changes from the second scenario to the third scenario, the master system is the second hardware system, and the master operating system is the second operating system. The slave system is the first hardware system, and the slave operating system is the first operating system. The second sub-screen is the first part of the display area and the first sub-screen is the second part of the display area. The first sub-screen switch is the second switch.

In the third scenario, the display mode selected by the selection module may be such one where the first and second sub-screens correspond to the slave and master systems, respectively. In such case, the EC module instructs the first sub-screen switch and the second sub-screen switch to select an input connected to the second display controller and an input connected to the first display controller, respectively. The first sub-screen switch connects the second display controller to the first sub-screen, and the second sub-screen switch connects the first display controller to the second sub-screen. That is, the second sub-screen displays information to be displayed of the master operating system and the first sub-screen displays information to be displayed of the slave operating system.

In the embodiment, the first sub-screen switch and the second sub-screen switch may be embedded into a LCD panel, or may be placed on the main board of the notebook. The selection module and the EC module may be reused in a Hybrid system.

An embodiment of the portable terminal according to the invention is provided, corresponding to the embodiment of the display output method of the portable terminal according to the invention.

The first embodiment of the portable terminal according to the invention is shown in

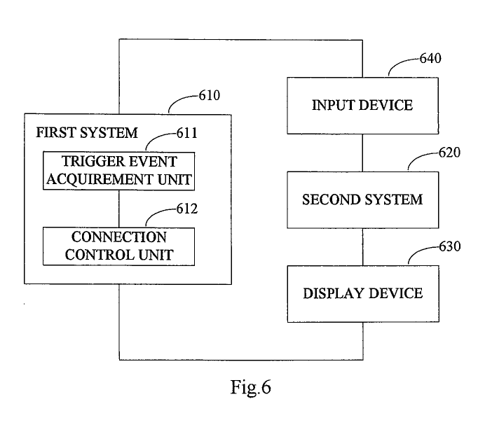

FIG. 6. The portable terminal includes a first system 610, a second system 620, a display device 630 including a display area shared by the first system 610 and the second system 620, and an input device 640 for controlling movement of a cursor. Output data of the first system 610 is displayed on a first part of the display area controlled by the first system 610, and output data of the second system 620 is displayed on a second part of the display area controlled by the second system 620.

The first system 610 includes:
a trigger event acquirement unit 611 for acquiring a trigger switching event corresponding to an input operation on the input device when the cursor is located on the first part; and
a connection control unit 612 for controlling the input device to switch to be connected to the second system 620 based on the trigger switching event, the cursor being displayed on the second part when the input device is connected to the second system 620.

Moreover, the first system 610 may further include (not shown in FIG. 6) a state determination and performance unit for determining state of the second system and waking the second system up if it is determined that the second system is in a non-operating state, and the second system 620 may further include (not shown in FIG. 6) a display output control unit for controlling displaying of output data on the second part.

Moreover, the first system 610 may include a first storage and the second system 620 may include a second storage, and a communication channel may be established between the first storage and the second storage. The first system may further include (not shown in FIG. 6): a data movement acquirement unit for acquiring a data movement event inputted from the input device when the cursor is located on the first part, and a data transmission unit for transmitting data corresponding to the data movement event via the communication channel from the first storage to the second storage. Particularly, the data transmission unit may include a destination address acquirement unit for acquiring a destination address corresponding to the location of the cursor on the second part, and a data transmission performance unit for transmitting the data via the communication channel from the first storage to a storage space corresponding to the destination address in the second storage.

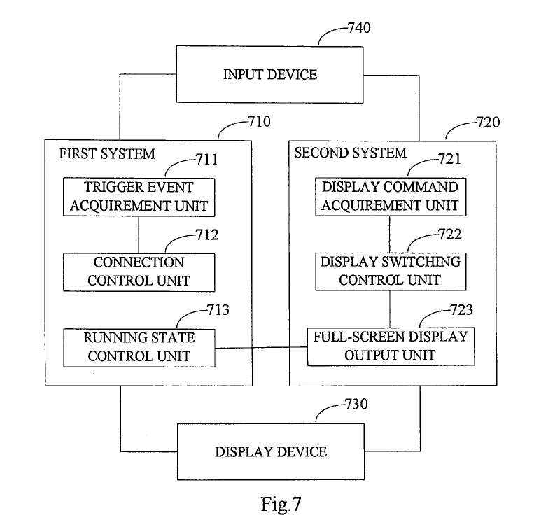

The second embodiment of the portable terminal according to the invention is shown in FIG. 7. The portable terminal includes a first system 710, a second system 720, a display device 730 including a display area shared by the first system 710 and the second system 720, and an input device 740 for controlling movement of a cursor. Output data of the first system 710 is displayed on a first part of the display area controlled by the first system 710, and output data of the second system 720 is displayed on a second part of the display area controlled by the second system 720.

The first system 710 may include:
a trigger event acquirement unit 711 for acquiring a trigger switching event corresponding to an input operation on the input device when the cursor is located on the first part;
a connection control unit 712 for controlling the input device to switch to be connected to the second system 720 based on the trigger switching event, the cursor being displayed on the second part when the input device is connected to the second system 720; and
a running state control unit for controlling the first system to enter into a background running state in a full-screen display mode.

The second system 720 may include:
a display command acquirement unit 721 for acquiring a full-screen display command inputted from the input device when the cursor is located on the second part,
a display switching control unit 722 for switching the first part from being under the control of the first system to being under the control of the second system based on the full-screen display command, and
a full-screen display output unit 723 for controlling the input device to perform a full-screen display on the whole display area formed by the first and second parts. The first system 710 may further include a running state control unit 713 for controlling the first system to enter into the background running state in the full-screen display mode.

Moreover, the display command acquirement unit 721 may further acquire a dual-screen display command inputted from the input device. The display switching control unit 722 may further switch the first part to the control of the first system. The running state control unit 713 may further control the first system to enter into in a foreground display state when the first part is under the control of the first system.

According to the solutions of the embodiments of the present invention, the first system acquires a trigger switching event corresponding to the input operation on the input device when the cursor is located on the first part of the display area, controls the input device to switch to be connected to the second system based on the trigger switching event, and causes the cursor to be displayed on the second part when the input device is connected to the second system. When the embodiments of the present inventions are applied to a hybrid portable terminal to perform an output operation, a seamless switching of the display output between the display parts of two systems can be accomplished through corresponding operations of the cursor when moving the input device, and thereby the switching time for the display output is reduced and the user operation is facilitated.

It can be appreciated by those skilled in the art that the solutions according to the embodiments of the present invention can be implemented in software in combination with a general hardware platform as desired. Therefore, the solutions according to the embodiments of the present invention, or the portions thereof contributive to the prior art, can be substantially embodied in a software product. Such a computer software product may be stored in a storage medium such as ROM/RAM, magnetic disk or optical disc. The storage medium may carry instructions for enabling a computer device (which may be a personal computer, a server or a network device) to implement the method according to the embodiments (or some portion thereof) according to the present invention.

The present invention is not limited to the above described embodiments. A number of modifications, equivalent alternatives and improvements can be made by those skilled in the art without departing from the spirit and principle of the present invention. These modifications, equivalent alternatives and improvements are encompassed by the scope of the present invention.

1. A display output method of a portable terminal, which is applied to the portable terminal comprising at least a first system and a second system, the portable terminal comprising a display device including a display area shared by the first and second systems, and an input device shared by the first and second systems for controlling movement of a cursor, output data from the first system being displayed on a first part of the display area controlled by the first system, the first system controlling input data of the first system to be displayed on the first part of the display area controlled by the first system, output data from the second system being displayed on a second part of the display area controlled by the second system, the second system controlling input data of the second system to be displayed on the second part of the display area controlled by the second system, the input device being connected to the first system and the first system responding to an operation of the cursor on the first part if the cursor is located on the first part, and the input device being connected to the second system and the second system responding to an operation of the cursor on the second part if the cursor is located on the second part, the display output method comprising:
acquiring, by the first system, a trigger switching event corresponding to an input operation on the input device when the cursor is located on the first part, and
controlling, by the first system, the input device to switch to be connected to the second system based on the trigger switching event, and
causing the cursor to be displayed on the second part when the input device is connected to the second system.

2. The method of claim 1, wherein the method further comprises, before controlling the input device to switch to be connected to the second system based on the trigger switching event:
determining a state of the second system, waking the second system up if it is determined that the second system is in a non-operating state, and then the second system displaying output data on the second part.

3. The method of claim 1, wherein the trigger switching event corresponding to an input operation comprises one of the following: the cursor moving to a boundary of the first part of the display area; receiving a click command requesting switching to the second part; or receiving a selection command requesting switching to the second part.

4. The method of claim 1, wherein the first system comprises a first storage and the second system comprises a second storage, a communication channel being established between the first storage and the second storage,
the method further comprises:
acquiring by the first system a data movement event inputted from the input device when the cursor is located on the first part, and
transmitting by the first system data corresponding to the data movement event via the communication channel from the first storage to the second storage.

5. The method of claim 4, wherein the data movement event comprises one of the following: the cursor moving to drag data from the first part to the second part; the cursor moving to copy data from the first part to the second part; or receiving a command requesting transmission of data from the first system to the second system.

6. The method of claim 4, wherein transmitting by the first system data corresponding to the data movement event via the communication channel from the first storage to the second storage comprises:
acquiring a destination address corresponding to the location of the cursor on the second part, and
transmitting the data via the communication channel from the first storage to a storage space corresponding to the destination address in the second storage.

7. The method of claim 1, further comprises:
acquiring by the second system a full-screen display command inputted from the input device when the cursor is located on the second part,
switching by the second system based on the full-screen display command, the first part from being under the control of the first system to being under the control of the second system,
controlling by the second system the input device to perform a full-screen display on the display area formed by the first and second parts, and
causing the first system to enter into a background running state.

8. The method of claim 7, further comprises:
switching the first part to being under the control of the first system when the second system acquires a dual-screen display command inputted from the input device, and
causing the first system to enter into a foreground display state.

9. A portable terminal comprising a first system, a second system, a display device including a display area shared by the first and second systems, and an input device shared by the first and second systems for controlling movement of a cursor, output data from the first system being displayed on a first part of the display area controlled by the first system, the first system controlling input data of the first system to be displayed on the first part of the display area controlled by the first system, output data from the second system being displayed on a second part of the display area controlled by the second system, the second system controlling input data of the second system to be displayed on the second part of the display area controlled by the second system, the input device being connected to the first system and the first system responding to an operation of the cursor on the first part if the cursor is located on the first part, and the input device being connected to the second system and the second system responding to an operation of the cursor on the second part if the cursor is located on the second part, the first system comprising:
a trigger event acquirement unit for acquiring a trigger switching event corresponding to an input operation on the input device when the cursor is located on the first part; and
a connection control unit for controlling the input device to switch to be connected to the second system based on the trigger switching event, the cursor being displayed on the second part when the input device is connected to the second system.

10. The portable terminal of claim 9, wherein
the first system further comprises:
a state determination and performance unit for determining a state of the second system and waking the second system up if it is determined that the second system is in a non-operating state, and
the second system comprises:
a display output control unit for controlling output data to be displayed on the second part.

11. The portable terminal of claim 9, wherein the first system further comprises a first storage and the second system further comprises a second storage, a communication channel being established between the first storage and the second storage, and
the first system further comprises:
a data movement acquirement unit for acquiring a data movement event inputted from the input device when the cursor is located on the first part, and
a data transmission unit for transmitting data corresponding to the data movement event via the communication channel from the first storage to the second storage.

12. The portable terminal of claim 11, wherein the data transmission unit comprises:
a destination address acquirement unit for acquiring a destination address corresponding to the location of the cursor on the second part, and
a data transmission performance unit for transmitting the data via the communication channel from the first storage to a storage space corresponding to the destination address in the second storage.

13. The portable terminal of claim 9, wherein the second system comprises:
a display command acquirement unit for acquiring a full-screen display command inputted from the input device when the cursor is located on the second part,
a display switching control unit for switching the first part from being under the control of the first system to being under the control of the second system based on the full screen display command, and
a full screen display output unit for controlling the input device to perform a full-screen display on the display area formed by the first and second parts, and
the first system further comprises:
a running state control unit for controlling the first system to enter into a background running state in the full-screen display mode.

14. The portable terminal of claim 13, wherein the display command acquirement unit further acquires a dual-screen display command inputted from the input device, the display switching control unit further controls the first part switch to being under the control of the first system, and the running state control unit further controls the first system to enter into a foreground display state when the first part is under the control of the first system.

15. A portable terminal comprising a first system, a second system, a display device including a display area shared by the first and second systems and an input device shared by the first and second systems for controlling movement of a cursor, output data from the first system being displayed on a first part of the display area controlled by the first system, the first system controlling input data of the first system to be displayed on the first part of the display area controlled by the first system, output data from the second system being displayed on a second part of the display area controlled by the second system, the second system controlling input data of the second system to be displayed on the second part of the display area controlled by the second system, the input device being connected to the first system and the first system responding to an operation of the cursor on the first part if the cursor is located on the first part, and the input device being connected to the second system and the second system responding to an operation of the cursor on the second part if the cursor is located on the second part, the portable terminal comprising:
a first switch connected to the first system, the second system and a first sub-screen corresponding to the first part of the display area, respectively,
a second switch connected to the second system, the first system and a second sub-screen corresponding to the second part of the display area, respectively, and
a controller connected to the first switch and the second switch respectively to control the first switch to be connected to the first system and the second switch to be connected to the second system, wherein the first system controls input data of the first system to be displayed on the first part of the display area, and the second system controls input data of the second system to be displayed on the second part of the display area.

16. The portable terminal of claim 15, further comprises:
a power source control module for supplying power to the first sub-screen and/or the second sub-screen based on the control of the controller.

17. The portable terminal of claim 15, wherein
the controller controls the first switch and the second switch to connect to the second system according to a second system full-screen display command, and wherein the second system controls input data of the second system to be displayed on an area formed by the first and second parts of the display area.

18. The portable terminal of claim 15, wherein
the controller controls the first switch and the second switch to connect to the first system according to a first system full-screen display command, and wherein the first system controls input data of the first system to be displayed on an area formed by the first and second parts of the display area
